(19) United States
(12) Patent Application Publication
(10) Pub. No.: US 2009/0167537 A1
(43) Pub. Date: Jul. 2, 2009

(54) MINIMIZING ELECTRICAL OUTLET SAFETY FAILURES DUE TO OVER TEMPERATURE CONDITION

(76) Inventors: Norbert A. Feliss, Aptos, CA (US); Karl Arthur Flechsig, Los Gatos, CA (US); Donald Ray Gillis, San Jose, CA (US); Sylvia Lui Lee, San Jose, CA (US)

Correspondence Address: ZILKA-KOTAB, PC- HIT, P.O. BOX 721120, SAN JOSE, CA, 95172-1120, US

(21) Appl. No.: 11/966,142

(22) Filed: Dec. 28, 2007

(51) Int. Cl. G08B 21/00

(52) U.S. Cl. 340/584; 340/635

(57) ABSTRACT

A device and system for monitoring the condition of an electrical outlet such as a 110 volt or 220 volt outlet to alert a user to a dangerous situation and to interrupt power to the circuit in the event of the dangerous condition. The device monitors the circuit for degradation to the electrical outlet. The system can include a temperature sensor voltage meter or particle detector (smoke detector) connected with a power outlet. When a parameter of a circuit exceed a predetermined level (indicating the outlet has degraded to an unsafe level) a warning can be reported and if necessary power to the device can be adjusted or interrupted.

### FIELD OF THE INVENTION

The present invention relates to circuitry for detecting degraded electrical outlet circuitry and for preventing potentially dangerous conditions resulting therefrom.

### BACKGROUND OF THE INVENTION

The coming advent of plug-in hybrid electric and pure electric vehicles will soon be an integral part of the transportation system. The use of such vehicles raises a challenge that actually extends beyond the use of such vehicles, to the use of electrical appliances generally. The refueling or charging of these vehicles is from the power distribution grid, from basic duplex outlets in homes and workplaces. The refueling or charging operation can severely strain the 120 volt duplex connections of many homes, especially if those duplex connections are very old as is the case in many homes and workplaces. While such outlets can appear to be perfectly fine and may function for many lower demand appliances, these outlets may have degraded over years of service, setting up dangerous situations without the knowledge of the user.

### SUMMARY OF THE INVENTION

The present invention provides a power supply apparatus for monitoring the condition of a power outlet. The device can include a power outlet; a power supply line, connected with the power outlet; and a sensor connected with the power outlet, the sensor being operable to generate a signal in response to a degradation of the power outlet.

The invention can provide a device and system for monitoring the condition of an electrical outlet such as a 110 volt or 220 volt outlet to alert a user to a dangerous situation and to interrupt power to the circuit in the event of the dangerous condition. The device can monitor the circuit for degradation to the electrical outlet. The system can include a temperature sensor, voltage meter or particle detector (smoke detector) connected with a power outlet. When a parameter of a circuit exceed a predetermined level (indicating the outlet has degraded to an unsafe level) a warning can be reported and if necessary power to the device can be adjusted or interrupted.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a more complete understanding of the nature and advantages of this invention, as well as the preferred mode of use, reference should be made to the following detailed description read in conjunction with the accompanying drawings which are not to scale.

FIG. 1 is a flow chart illustrating a method for monitoring the condition of an electrical outlet circuit;

FIG. 2 is a flow chart, according to an alternate embodiment of the invention, for monitoring the condition of an electrical outlet circuit;

FIG. 3 is a schematic illustration of a device for supplying power to an appliance and for monitoring the condition of an electrical outlet into which the device is connected;

FIG. 4 is a schematic illustration of a device, according to an alternate embodiment of the invention, for supplying power to an appliance and for monitoring the condition of an electrical outlet into which the device is connected;

FIG. 5 is a schematic illustration of a circuitry incorporated into or connected with an electrical outlet for monitoring the condition of the electrical outlet;

FIG. 6 is a schematic illustration, according to an alternate embodiment of the invention, of a circuitry incorporated into or connected with an electrical outlet for monitoring the condition of the electrical outlet;

FIG. 7 is a schematic illustration, according to yet another embodiment of the invention, of a circuitry incorporated into or connected with an electrical outlet for monitoring the condition of the electrical outlet;

FIG. 8 is a schematic illustration of a temperature sensor integrated into circuitry of a power outlet; and

FIG. 9 is a schematic illustration of a temperature sensor integrated into ground fault interrupter circuitry.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

As discussed above, the current and future advent of appliances such as electric vehicles have the potential to strain circuits in ways not previously experienced. For Example, duplex circuits in households and workplaces can be very old and severely degraded. While this degradation may not be a problem when using appliances that draw relatively small loads or that draw loads only for a relatively short period of time, a device such as an electrical vehicle can draw very high loads over an extended period of time, such as overnight. In a degraded duplex outlet, this can cause sever Joule heating, which can ultimately result in failure of the circuit, or could even cause a fire or other catastrophic event.

The present invention provides a device or system that can warn a user of the possibility of such an event, and that can prevent such an event from occurring in the first place, by regulating current flow or by giving a user advanced warning so that repairs can be made before a degraded circuit causes a circuit failure, fire or other catastrophic event.

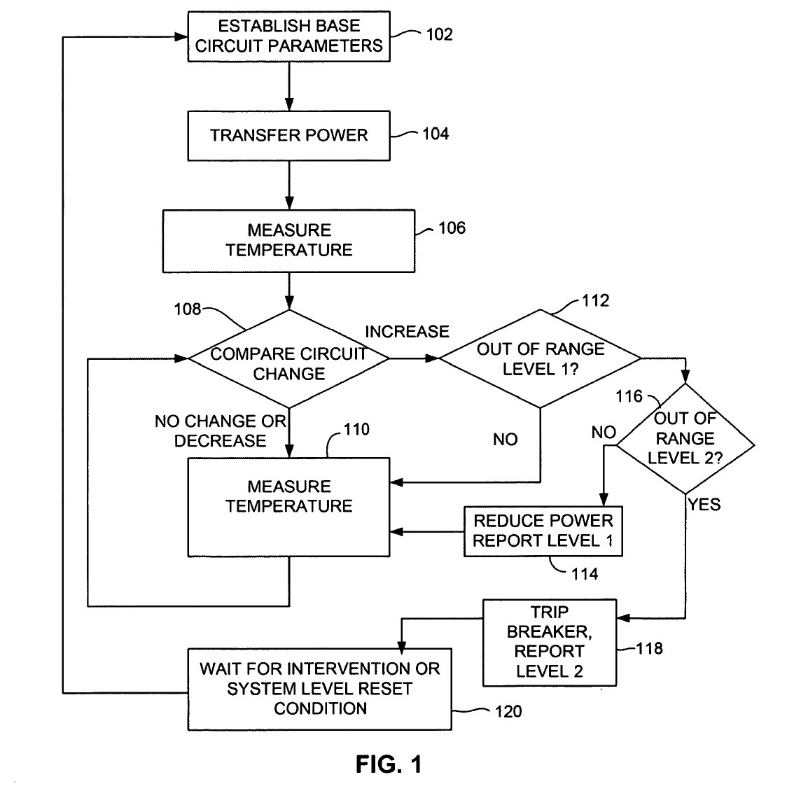

With reference to FIG. 1, in one embodiment of the invention, a device is provided that can detect degradation of a circuit and reduce power accordingly to prevent excessive heating of the circuit. The device can be a stand alone device such as a device incorporated into a power cord for delivering power to an appliance or could be incorporated into an electrical outlet itself.

The device includes circuitry or logic 100 for determining that a temperature has reached an excessive level. First in a step 102 a base temperature can be established. This can be set by an operator or could be preset, such as to manufacture's specifications or by some other method. Then, in a step 104 power is transferred to an appliance of choice such as an electric vehicle. In a step 106, a temperature of the circuitry is measured and then, in a step 108 the current temperature of the circuit is compared with the base temperature to determine a temperature change or delta temperature (difference between the base temperature and the current temperature). If there is no temperature change, or if the temperature decreases, then the system continues to step 110 to continue detecting the temperature of the circuit, for continued comparison with the base temperature (returning to step 108).

If however, it is determined that the temperature has increased, the system continues to a decision step 112 to determine whether the temperature increases is beyond a predetermined acceptable first range or threshold (level 1). If the temperature increase is within an acceptable first range or threshold, then the system continues to step 110 to continue monitoring the temperature. If, however, the temperature increase exceeds the acceptable first range or threshold, then the system continues to step 114 to report that level 1 has been exceeded and possibly to or interrupt or reduce the power delivered to the appliance. If the temperature increase exceeds a first threshold (level 1), then the system continue to a decision step 116 to determine if the temperature exceeds a second threshold (level 2). If the temperature does exceed the second threshold (level 2), then the system continued to step 118 to interrupt power (such as by tripping a circuit breaker) and also to report that the second threshold (level 2) has been exceeded. The system then continues to step 120 to wait for an intervention (e.g. resetting the circuit breaker) or waiting for a system level reset contention.

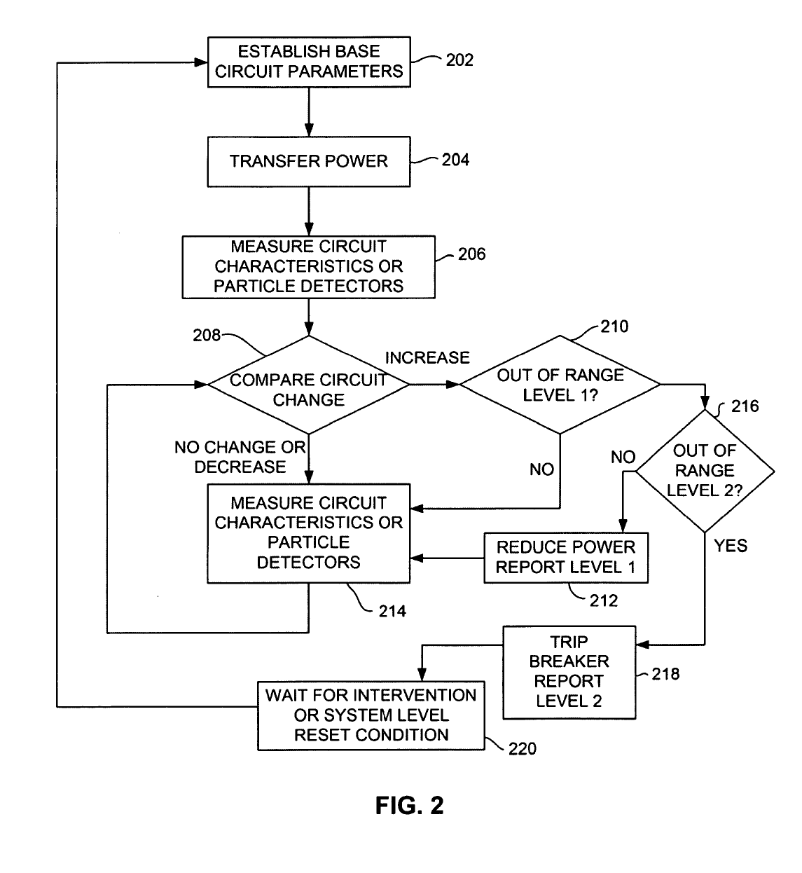

With reference now to FIG. 2, a device can be implemented to monitor the safety of a circuit by measuring parameters of the circuit itself. Such parameters can include, for example, the resistance of the circuit, the dynamic impedance of the circuit and the initial voltage at time=0, compared to the voltage under load. The sensor can also be a particle detector (smoke) to determine heating to the point of flammability. With this in mind, in a step 202 base parameters for the circuit are established. As mentioned above, these can be parameters such as impedance, voltage, etc. Then, in a step 204, power is transferred to an appliance. While this power is being transferred, the relevant circuit parameters are measured in a step 206. Then, in a step 208 the measured circuit parameters are compared with the base circuit parameters and a determination is made as to whether or not the parameters have changed in a manner that might indicate circuit degradation. For example, an impedance or voltage drop of a circuit could indicate degradation of the circuit. If circuit parameter changes indicate circuit degradation, then the system continues to step 210 where a determination is made as to whether the circuit changes are beyond an acceptable first range (level 1). If, in step 210 it is determined that the parameter change is within an acceptable range, then the system continues to step 214 to continue monitoring circuit parameters. If, in decision step 210 it is determined that the circuit conditions have in fact exceeded the first range (level 1), then the system continues to a decision step 216 to determine whether the circuit changes are beyond a second range (level 2). If the answer is no, then the power delivered through the circuit is reduced, and level 1 is reported (step 212). Circuit measurement then continues in a step 214. If the answer to decision step 216 is yes (level 2 has been exceeded) then the system continues to step 218 to interrupt current (such as by tripping a circuit breaker) and level 2 is reported. The system then continues to step 220 to wait for intervention (such as circuit breaker reset) or for a system level reset condition.

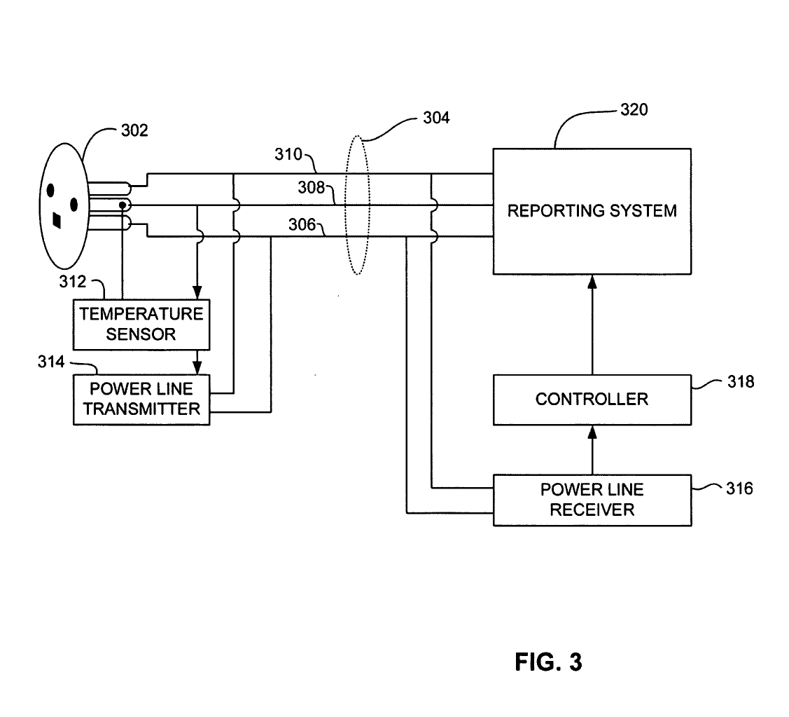

As mentioned above, the invention can be embodied in an outlet to monitor the condition (ie. deterioration) of a power outlet circuit. With reference, then, to FIG. 3, a power outlet 302 is provided such as a 10 or 220 volt power outlet of a home or place of business. The outlet 302 is connected with a power conductors 304 that includes first second and third electrical lines 306, 308, 310, that can include a hot line 310, a neutral line 306 and a ground line 308. According to this embodiment of the invention, the lines 306, 308, 310 of the power conductor 304 can be used to deliver a signal to a reporting system 320. To this end, a signal from the temperature sensor 312 is delivered to a power line transmitter 314, which generates a signal corresponding to the temperature of the of the power outlet 302. This signal from the power line transmitter 314 is fed to one or more of the lines 306, 308, 310 of the power conductor, where it is transmitted to a power receiver 316. The power receiver reads the signal delivered from the power line transmitter (via the lines 306, 310) and delivers a signal to a controller 318. Therefore, the temperature sensor 312 is in communication with the controller 318. If the sensed temperature is too large (indicating degradation of the circuit) the controller can send a signal to the reporting system 320 to warn of a hazardous situation at the device being powered or charged (not illustrated). The sensor can be, for example, a temperature or particle detector and also may include a transformer. It should also be pointed out that, while the device is being described as a device that detects a temperature increase, the device could also be constructed to detect and respond to one or more other circuit parameters, such as impedance or voltage, such as discussed with reference to FIG. 2.

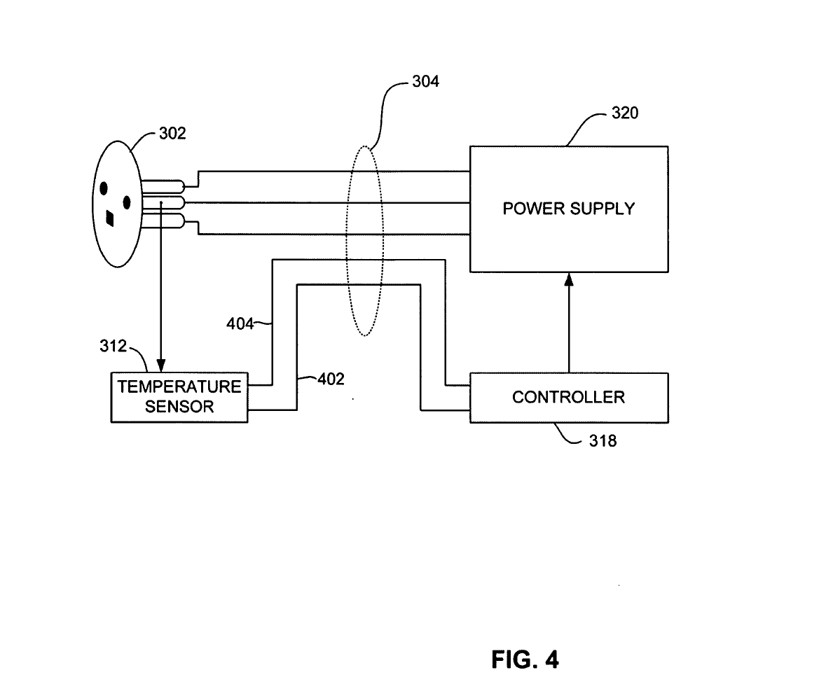

With reference now to FIG. 4, another embodiment of the invention does not use the leads of the power cord 304 to transmit circuit or temperature data. According to this embodiment of the invention, a temperature signal is delivered from the power plug 302 to a temperature sensor 312. The temperature sensor 312 is in communication with the controller 318. One or a pair of leads 402, 404 delivers a signal from the temperature sensor directly to the controller 318, which can deliver a signal to the power supply to adjust the power (e.g. lower the current or interrupt the circuit) delivered to the outlet and to the device being powered (not shown) in the event that a temperature increase (or other circuit data) indicates degradation of the power outlet circuit (not shown).

Reporting Circuit Condition:

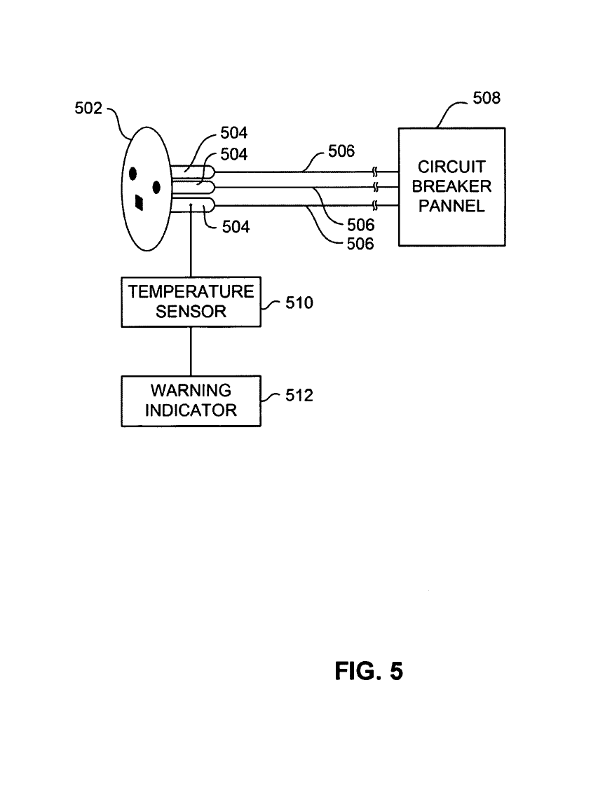

The invention can be embodied in a device incorporated into an outlet circuit itself to either alert a user of circuit degradation or to interrupt the circuit to prevent circuit failure. With reference now to FIG. 5, an electrical outlet 502, such as a 110 volt or 220 volt power outlet is provided having a plurality of receptacles 504 for receiving tines of a power plug (not shown in FIG. 5). The receptacles 504 are connected with electrical leads 506 that supply power from a circuit beaker panel 508 or other power supply.

One or more of the receptacles 504 (or some other relevant part of the outlet 502) is connected with a temperature sensor 510 such as a thermistor. It should be pointed out that the invention is being described as using a temperature sensor 510, however the temperature sensor could be replaced with another device that can monitor some other parameter of the circuit such as a voltage or particle sensor. Therefore, the sensor 502 could also be a voltmeter or particle sensor.

The temperature sensor monitors the temperature of the tine 504 and, if the temperature exceeds a certain predetermined threshold, the temperature sensor 510 sends a signal to a warning indicator 512, which is activated to alert a user of a dangerous condition. The warning indicator can be a visual display (such as a steady or flashing LED) display, or could be an audible warning such as an alarm buzzer. Furthermore, the warning indicator need not be located directly at the location of outlet, but could be a remote device that can warn a user such as a home owner at some remote location, or could alert a centralized agency such as a local fire department, alarm company, etc. that a potentially dangerous situation exists.

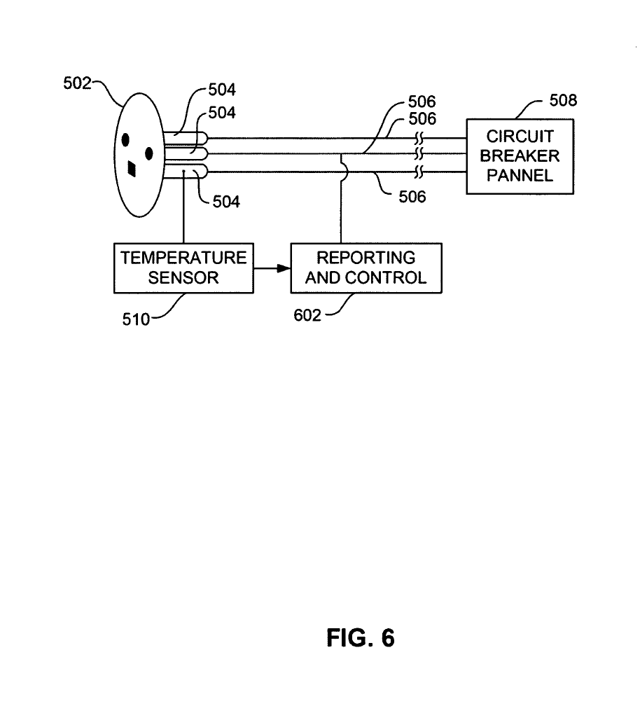

With reference now to FIG. 6, according to another embodiment of the invention, a temperature sensor 510 (or other circuit monitoring device as mentioned above) is connected with a tine 504 of the outlet 502. In the event that the temperature (or other circuit parameter) exceeds a predetermined threshold, the sensor 510 sends a signal to an external device to enable power regulator 602, which is connected in series with one or more of the electrical lines 506. The power regulator 602, which can be a voltage regulator, current regulator, etc., upon receiving the signal from the sensor 510 functions to actively reduce the amount of current delivered to the outlet 502. The sensor then continues to monitor the load at the outlet 502, and if the dangerous condition persists, the sensor 510 continues to send a signal to the power regulator 602 to further reduce power to the outlet 502.

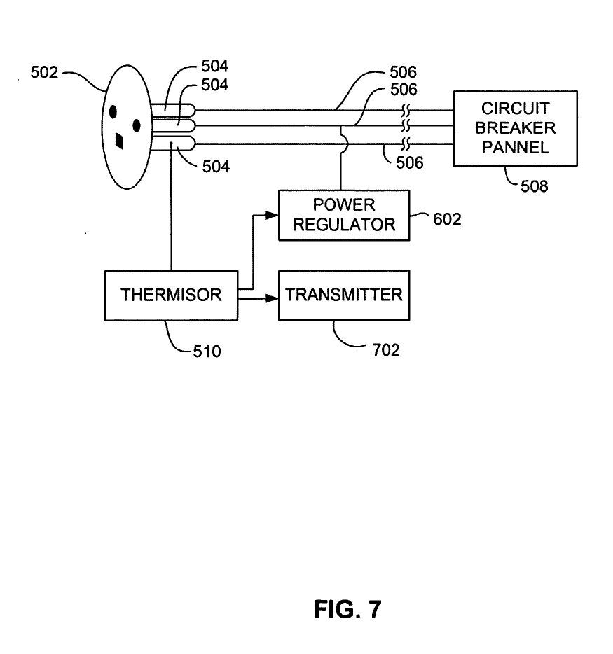

With reference now to FIG. 7, according to another embodiment of the invention, when the temperature sensor (or other circuit monitoring device) detects a potentially dangerous situation such as a temperature exceeding a predetermined threshold, then the temperature sensor sends a signal to a power regulator 602 to reduce the current delivered to the outlet 502, as describe above, with reference to FIG. 6. In addition however, the sensor 510 can send a signal to a transmitter that can send a signal (such as by an RF signal) to notify an appropriate user or agency of a potentially dangerous situation. Such a transmitted signal could be a signal to a fire department or alarm company, or could be, for example, a message delivered (for example) via cell phone to a home owner or other user.

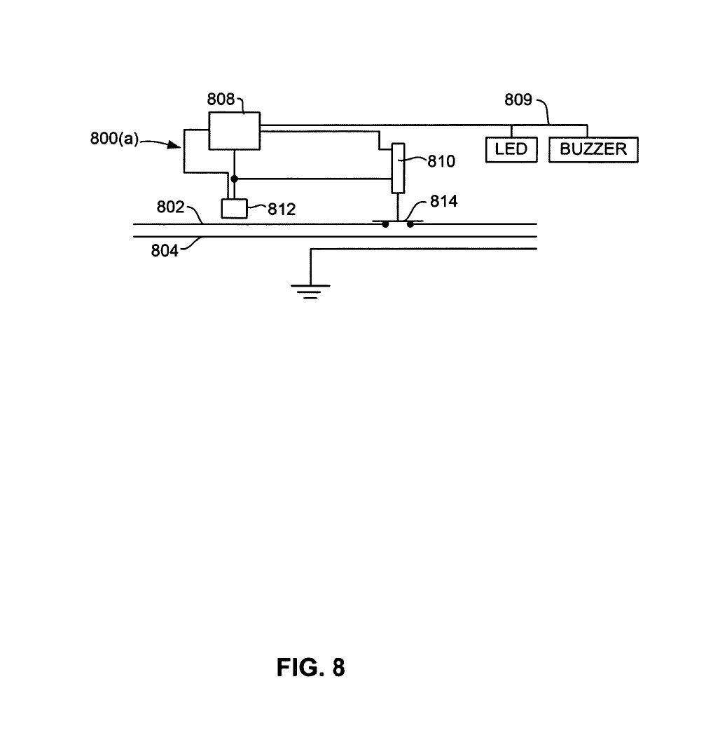

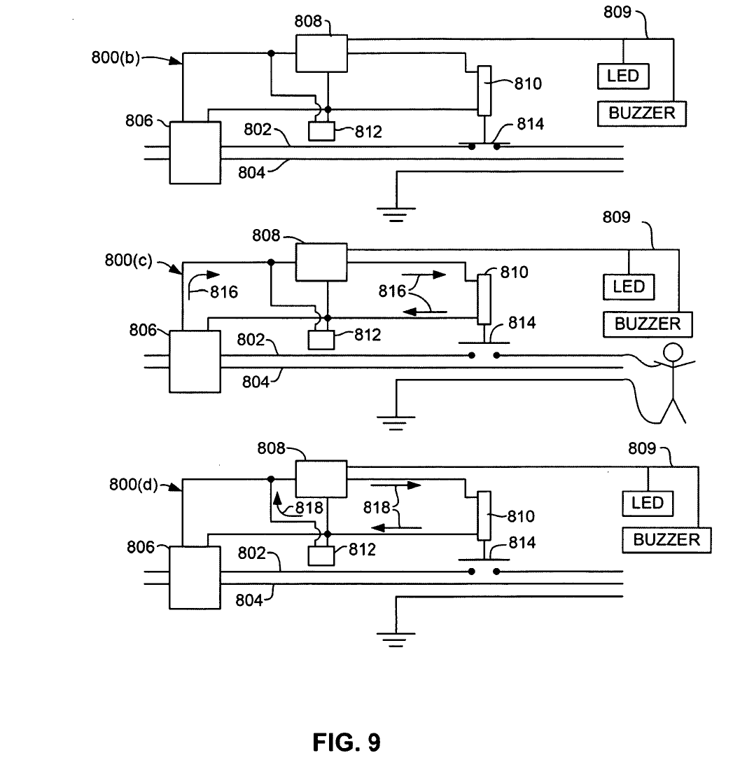

With reference now to FIG. 8, a block diagram of the circuitry for deactivating an outlet in the event of an overheating. An additional embodiment in FIG. 9 is to combine the functional elements of the thermal sensor, reporting and interrupt functions with a Ground Fault Interrupter Circuit (GFIC). FIG. 9 shows a circuit 800 in three different conditions labeled as 800(b), 800(c) and 800(d). The circuit includes a hot line 802 and a neutral line 804. The sensing element 812 can be individually or any combination of a temperature sensor, voltage sensor or particle sensor. The control unit 808 interacts with the 809 reporting function (LED/Alarm) and circuit interruption. In the combination unit depicted in FIG. 8(b) the primary conductors 802, 804 pass through a transformer 806. The transformer is connected with sense electronics 808 and also with a circuit breaker solenoid 810. The 810 functional element can also be a semiconductor device. A temperature sensor 812 is also connected with the sense electronics 808, solenoid 810 and transformer 806.

Circuits 800(a) and 800(b) show the circuit during normal operation when there is no short to ground and no excessive temperature increase. As can be seen, the hot line 802 and the neutral line 804 both pass through the transformer. Since the currents are flowing in opposite direction through the lines 802, 804 there is a zero net magnetic field generated by the two lines, and the transformer 806 does not generate a current. Also, since no high temperature condition exists, the temperature sensor also does not generate a signal in the form of a resistance change. In this case, no current is applied to the solenoid 810 and the associated switch 814 remains closed.

The example shown as 800(c) shows the circuit in a ground fault condition. This is the situation where the hot line 802 has been grounded. In that case, current flows to ground and does not return through the neutral line 804. The transformer detects this net difference in currents between lines 802, 804 (which no longer cancel one another out) and generates a current 816 which at level 1 signals a condition of concern and level 2 condition that trips the solenoid 810 opening the circuit switch 814 and reporting the condition on 809.

The example shown as 800(d) shows the circuit responding to a high temperature condition, such as from outlet degradation described above. The temperature sensor 812 detects this increase in temperature and by generating a signal in the form of a resistance change in the temperature sensor 812. The sensor electronics circuitry 808 detects this resistance change and generates a current 818 to report a level 1 signal a condition and level 2 condition that trip the solenoid 810, thereby opening the switch 814 and deactivating the circuit. As can be seen, then, the temperature sensor 812 and sensor circuitry 808 used to prevent damage due to a degraded circuit, can be integrated into a system that gives the benefits of existing GFI function to utilize the solenoid 810 and switch 814.

The sensor circuitry 808 can be programmed to account for ambient conditions in order to prevent false trips. For example, the sensor circuitry can be programmed to monitor ambient temperature and factor that temperature when determining the amount of resistance change needed to trigger a signal to trip the solenoid 810. The sensor can, therefore, on a very hot day, determine that a resistance change of the temperature sensor is due to this ambient temperature increase on not to overheating of the circuit. Similarly, the sensor circuitry can, on a very cold day, determine that a lower increase in resistance is necessary to determine that the circuit has degraded and can generate a signal current 818 in response to a smaller resistance change of the temperature sensor.

While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A power supply apparatus, comprising:
a power outlet;
a power supply line, connected with the power outlet; and
a sensor connected with the power outlet, the sensor being operable to generate a signal in response to a degradation of the power outlet.

2. A power supply apparatus as in claim 1 wherein the sensor is a temperature sensor.

3. A power supply apparatus as in claim 1 wherein the sensor is a thermistor and the signal is a change in resistance of the thermistor.

4. A power supply apparatus as in claim 1 wherein the sensor is a particle sensor.

5. A power supply apparatus as in claim 1 further comprising a controller circuitry connected with the sensor and the power supply line, the controller circuitry being functional to alter a current flow through the power supply line in response to the signal.

6. A power supply apparatus as in claim 1 wherein the sensor is a temperature sensor, the apparatus further comprising a circuit breaker connected with the power supply line the circuit breaker being operable to discontinue a current flow through the power supply line in response to the signal from the temperature sensor.

7. A power supply apparatus as in claim 1 wherein the sensor is a thermistor, and further comprising:
a solenoid;
sensor electronics connected with the thermistor to receive the signal from the thermistor, the sensor electronics being operable to activate the solenoid in response to the signal from the thermistor.

8. A power supply apparatus as in claim 1 further comprising:
a semiconductor based switch; and
sensor electronics connected with the sensor to receive the signal from the thermistor, the sensor electronics being operable to activate the semiconductor based switch in response to the signal from the sensor.

9. A power supply apparatus as in claim 1 further comprising ground fault interrupter circuitry including a solenoid and a switch connected with the power supply line, the solenoid being connected with the switch being operable to open the switch, and wherein the sensor is integrated with the ground fault interrupter circuitry to activate the solenoid in response to the signal from the sensor.

10. A power supply apparatus as in claim 1 further comprising ground fault interrupter circuitry including a solenoid and a switch connected with the power supply line, the solenoid being connected with the switch being operable to open the switch, and wherein the sensor is a thermistor and is integrated with the ground fault interrupter circuitry to activate the solenoid in response to the signal from the thermistor.

11. A power supply apparatus as in claim 1 further comprising a communication function to report a first level (level 1) as a warning condition and a second level (level 2) for interruption.

12. A power supply apparatus as in claim 1 further comprising a communication function for communicating with an external device and with a power regulator connected with the load, the power regulator being operable to regulate power delivery through the outlet in response to the signal from the sensor.

13. A power supply apparatus as in claim 1 wherein the sensor is a thermistor and further comprising a communication function connected with a power regulator connected with the power supply line and operable to regulate a power delivery through the power supply line in response to the signal from the sensor.

14. A power supply apparatus as in claim 1 wherein the sensor is a thermistor and further comprising a current regulator connected with the power supply line and operable to regulate a current delivery through the power supply line in response to the signal from the sensor.

15. A power supply apparatus as in claim 1 wherein the sensor detects an impedance of the outlet and further comprising a controller connected operable to control a current delivered through the power line in response to the signal from the sensor.

16. A power supply apparatus as in claim 1 wherein the sensor detects an impedance of the outlet and further comprising:
a circuit breaker connected with the power supply line; and
sensor circuitry connected with the sensor for receiving the signal from the sensor and operable to activate the circuit breaker in response to the signal from the sensor.

17. A power supply apparatus as in claim 1 wherein the sensor is a thermistor, the apparatus further comprising:
sensor electronics circuitry connected with the sensor for receiving the signal from the thermistor;
a circuit breaker connected with the power supply line; wherein
the sensor electronic circuitry is operable to receive the signal from the sensor and to activate the circuit breaker in response to the signal, the circuit breaker circuitry also being operable to monitor an ambient temperature and to factor the ambient temperature in a determination of whether to activate the circuit breaker.

18. A power supply apparatus, comprising:
a power outlet;
a power supply line, connected with the power outlet; and
a temperature sensor connected with the power outlet, the temperature sensor being operable to generate a signal corresponding to a temperature of the power outlet; and
circuitry for receiving the signal from the temperature sensor, and operable to alert a user in the event that the signal from the temperature sensor exceeds a predetermined threshold.

19. A power supply apparatus as in claim 18 wherein the circuitry activates a visual display in the event that the signal from the temperature sensor exceeds a predetermined threshold.

20. A power supply apparatus as in claim 18 wherein the circuitry activates an audible alarm in the event that the signal from the temperature sensor exceeds a predetermined threshold.

21. A power supply apparatus as in claim 18 wherein further comprising a power regulator connected with the power line for regulating a current flow through the power line in response to a signal from the circuitry for receiving a signal from the temperature sensor.

22. A power supply apparatus as in claim 18 wherein further comprising a circuit breaker connected with the power line for terminating a current flow through the power line in response to a signal from the circuitry for receiving a signal from the temperature sensor.

23. A power supply apparatus as in claim 1, further comprising:
circuitry for issuing a warning in the event that the signal from the circuit exceeds a predetermined threshold; and
a storage for storing a record of the warning.
